(19) United States
(12) Patent Application Publication
(10) Pub. No.: US 2025/0130815 A1
(43) Pub. Date: Apr. 24, 2025

(54) METHODS, APPARATUS, AND ARTICLES OF MANUFACTURE TO PARTITION A BOOT DRIVE FOR TWO OR MORE PROCESSOR CIRCUITS

(71) Applicant: Intel Corporation, Santa Clara, CA (US)

(72) Inventors: Thomas Martin Counihan, Fermoy (IE); Adrian Christopher Hoban, Cratloe (IE); Francesc Guim Bernat, Barcelona (ES)

(73) Assignee: Intel Corporation, Santa Clara, CA (US)

(21) Appl. No.: 19/000,523

(22) Filed: Dec. 23, 2024

(51) Int. Cl. G06F 9/4401

(52) U.S. Cl. CPC G06F 9/441

(57) ABSTRACT

Systems, apparatus, articles of manufacture, and methods are disclosed to partition a boot drive for two or more processor circuits. An example apparatus includes at least one first processor circuit to determine at least one first parameter for a first namespace and at least one second parameter for a second namespace to be configured for a non-volatile memory (NVM) boot drive, cause a first controller of the NVM boot drive to create the first namespace based on the at least one first parameter, and cause the first controller to create the second namespace based on the at least one second parameter. Also, the example at least one first processor circuit is to attach the first namespace to the first controller of the NVM boot drive, attach the second namespace to a second controller of the NVM boot drive, and attach the second controller to a bootloader of a second processor circuit.

### BACKGROUND

A boot drive is a memory or storage medium that stores data to load and run (e.g., boot) an operating system (OS) or other program for a computer. As such, a bootloader program executed by the computer can load and execute the OS or other program from the boot drive. In some examples, a boot drive is removable from a computer. Additionally or alternatively, a boot drive is not removable from a computer.

### BRIEF DESCRIPTION OF THE DRAWINGS

FIG. 1 is a block diagram of an example compute device in which example partition manager circuitry operates to partition an example boot drive for two or more example processor circuits.

FIG. 2 is a block diagram of an example implementation of the partition manager circuitry of FIG. 1.

FIG. 3 is a flowchart representative of example machine-readable instructions and/or example operations that may be executed, instantiated, and/or performed by example programmable circuitry to implement the partition manager circuitry of FIG. 2.

FIG. 4 is a sequence diagram illustrating example communication between the partition manager circuitry and other components of the compute device of FIG. 1 to initialize the boot drive of FIG. 1.

FIG. 5 is a block diagram of an example processing platform including programmable circuitry structured to execute, instantiate, and/or perform the example machine-readable instructions and/or perform the example operations of FIG. 3 to implement the partition manager circuitry of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine-readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Some compute devices include hybrid architectures that include multiple processor circuits. A hybrid architecture compute device can include multiple processor classes. Example processor classes include central processor units (CPUs), graphics processor units (GPUs), digital signal processors (DSPs), application specific integrated circuits (ASICs), and field programmable gate arrays (FPGAs). A hybrid architecture compute device can also include multiple types of processors within the same processor class.

For example, an infrastructure processor unit (IPU), sometimes referred to as a data processor unit (DPU), is a compute device that integrates one or more processor circuits with network interface circuitry. An IPU can include a first type of CPU to control networking operations and a second type of CPU to control management of the IPU. In some examples, the first type of CPU may have relatively greater computational capabilities than the second type of CPU. Another type of hybrid architecture compute device is an asymmetric multiprocessor (AMP). An AMP includes multiple interconnected CPUs where not all of the CPUs are treated equally. For example, an AMP may be configured to permit only one CPU to execute OS code and/or to permit only one CPU to perform input/output (I/O) operations. In some examples, a hybrid architecture is referred to as a heterogeneous architecture.

As described above, compute devices having hybrid architectures may be implemented in a single form factor and include two or more processor circuits. Also, compute devices having hybrid architectures may include different classes of processor circuits and/or different types of processor circuits within the same class (e.g., different CPU types, different GPU types, different FPGA types, etc.). As described above, the two or more processor circuits may serve different functions on a compute device or have different computational capabilities.

A compute device having a hybrid architecture implements one or more OSes for the processor circuits of the compute device. For example, a compute device having a hybrid architecture implements one OS for the processor circuits of the compute device. Additionally or alternatively, a compute device having a hybrid architecture implements a separate OS for each processor circuit of the compute device. In some examples, a compute device having a hybrid architecture implements one or more first OSes for some of the processor circuits of the compute device and one or more second OSes for others of the processor circuits of the compute device.

As such, a compute device having a hybrid architecture implements one or more boot drives to support the one or more OSes for the processor circuits of the compute device. In some examples, a compute device having a hybrid architecture implements a separate boot drive for each OS of the compute device. For example, each boot drive stores data for a separate OS and a separate processor circuit and software stack executed on the processor circuit manages bootup and persisting interactions with the boot drive. Implementing a separate boot drive for each OS of a compute device increases the number of boot drives that the compute device includes.

Additionally or alternatively, a compute device having a hybrid architecture implements a shared boot drive for two or more the OSes of the compute device. For example, one processor circuit and software stack executed on the processor circuit serve as a single interface with the boot drive for bootup and persisting interactions with the two or more OSes. In such examples, the processor circuit and software stack serve as a proxy between the two OSes and the boot drive, effectively gating access to the boot drive through the processor circuit.

Such a proxied boot drive introduces complexities for compute devices. For example, a proxied boot drive utilizes a leader processor circuit that services and brokers all read and/or write requests from peer processor circuits as described above. Additionally, a proxied boot drive does not permit each processor circuit running a separate OS to be assigned to and managed a separate partition. As described above, a proxied boot drive utilizes a leader processor circuit that manages all of the partitions of the boot drive. For example, the leader processor circuit handles partition management functions such as creating or deleting partitions on behalf of peer processor circuits.

Additionally, the leader processor circuit populates the assigned namespace with the OSes for peer processor circuits and coordinates the boot process for peer processor circuits. As such, when a compute device implements a proxied boot drive, one processor circuit is cognizant of the partitions and file systems of peer OSes. Thus, there is a forced coupling and related complexities between software installations and lifecycle managements between peer processor circuits.

Beyond design challenges, having different boot drives for each of subsystem of a compute device have direct implications to the end-users. For example, having different boot drives for each subsystem of a compute device results in a more complex form for a chassis design to accommodate all of the boot drives. Additionally, having different boot drives for each subsystem of a compute device results in ineffective I/O (e.g., peripheral component interconnect (PCI), PCI Express (PCIe), etc.) lane usage. Having different boot drives for each subsystem of a compute device can also result in a higher operating expense (OPEX) related to energy and management of the compute device. For example, having a larger number of components in a compute device increases a likelihood of failure of the compute device.

From the perspective of an edge deployment, the end-user implications of multiple boot drives can have increased implications for large scale deployments including not only capital expenditures (CAPEX) and OPEX, but also large carbon emissions (e.g., embodied and energy carbon dioxide). For example, 30% of the design of a large-scale edge deployment (e.g., supporting 170,000 edge locations) is concerned with environmentally focused key performance indicators (KPIs).

Examples disclosed herein allow different processor circuits in a compute device (e.g., an IPU, an AMP, a DPU, an XPU, etc.) to manage respective OS installations and subsequent lifecycle management for the different processor circuits from a single boot drive. For example, in disclosed examples, each processor circuit can manage its own OS installation and subsequent lifecycle management independent of peer processor circuits of a compute device, while all processor circuits of the compute device share a single boot drive. Example boot drives disclosed herein may be configured to operate in accordance with the NVM Express specification for accessing non-volatile memory (NVM) of a compute device.

As described above, examples disclosed herein include a compute device (e.g., an AMP) with a single physical boot drive that is shared between different OSes running on each processor circuit of the compute device. In such examples, disclosed methods, apparatus, and articles of manufacture increase parallelism as each processor circuit has direct access to its own command and read and/or write submission thread and/or stream. Additionally, disclosed methods, apparatus, and articles of manufacture reduce software complexity by eliminating the need for complex broker solutions such as a small computer systems interface (SCSI) specification (e.g., Internet SCSI (iSCSI), etc.) on both leader and follower processor circuits.

Examples disclosed herein also reduce the software complexity of the bootloader on each processor circuit of a compute device as a minimal subset of the NVMe specification is utilized to access the type of partition utilized herein. Examples disclosed herein also enhance security by facilitating the use of the replay protection memory lock feature of the NVMe specification for each independent processor circuit. Additionally, examples disclosed herein reduce the cost of implementing a compute device with a hybrid architecture as utilizing a single, partitioned boot drive avoids the need for multiple boot drives (e.g., flash storage connected via a serial peripheral interface (SPI) compliant interconnect) to store boot firmware for the processor circuits of the compute device. Reducing the number of boot drives of a compute device can also reduce carbon emissions (e.g., for large scale developments).

In disclosed examples, each processor circuit of a compute device having a hybrid architecture has independent, siloed access to a partition of a single boot drive and thus, can employ an independent policy for use of the partition. For example, methods, apparatus, and articles of manufacture disclosed herein allow each processor circuit of a compute device to select a file system (FS) for its own partition, one or more features (e.g., security, redundancy, etc.) to enable in the FS, a layout of the partition, and/or one or more techniques to upgrade software stored in the partition (e.g., split mode A/B, package management, etc.)

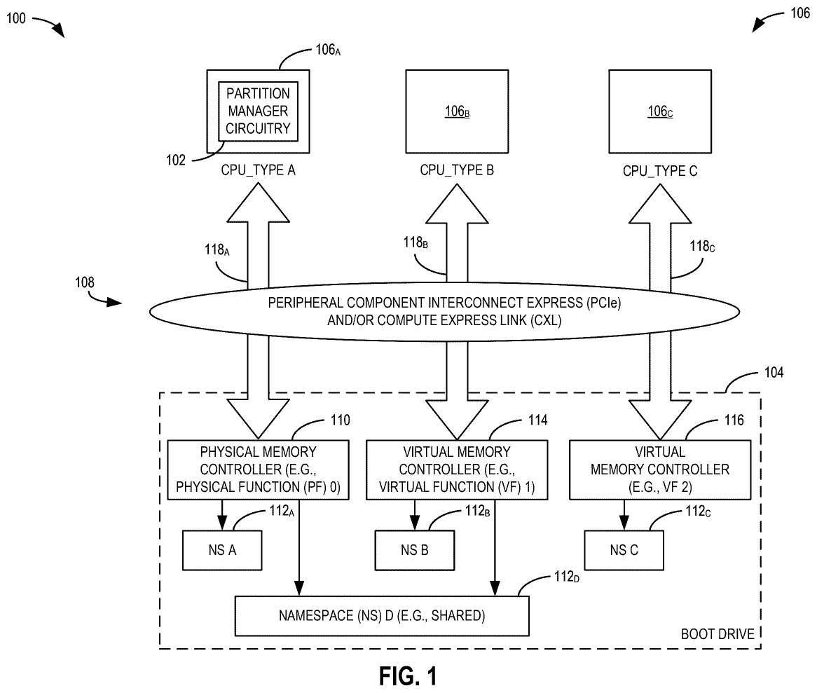

FIG. 1 is a block diagram of an example compute device 100 in which example partition manager circuitry 102 operates to partition an example boot drive 104 for two or more example processor circuits 106. In the example of FIG. 1, the partition manager circuitry 102 is implemented by hardware, software, and/or firmware. For example, the partition manager circuitry 102 is implemented as software and/or firmware stored in memory of the compute device 100 and is executed by a first example processor circuit 106_{A} of the compute device 100 from the memory. In some examples, the partition manager circuitry 102 is implemented by a Linux kernel that is configured as a trusted virtual function (VF) such that the first processor circuit 106_{A} can act as an administrator of the compute device 100. As such, the first processor circuit 106_{A}, through the partition manager circuitry 102, is designated control over the physical function (PF) of the boot drive 104.

In the illustrated example of FIG. 1, the compute device 100 also includes a second example processor circuit 106_{B} and a third example processor circuit 106_{C}. In the example of FIG. 1, the first processor circuit 106_{A} is a first type of processor circuit, the second processor circuit 106_{B} is a second type of processor circuit, and the third processor circuit 106_{C} is a third type of processor circuit. For example, the different types of the processor circuits 106 are processor circuits of a single processor class (e.g., CPUs) where each of the processor circuits 106 has different computational capabilities. Additionally or alternatively, the different types of the processor circuits 106 are processor circuits of different classes. In some examples, the different types of the processor circuits 106 are processor circuits that are to execute different OSes according to a system configuration of the compute device 100.

In the illustrated example of FIG. 1, the processor circuits 106 are coupled to the boot drive 104 via an example interface 108. For example, the interface 108 is implemented by an interconnect compliant with a PCI specification (e.g., PCI, PCIe, etc.). Additionally or alternatively, the interface 108 is implemented by an interconnect compliant with a CXL specification (e.g., CXL for cache-coherent accesses to system memory (CXL.cache or CXL.$), CXL for device memory (CXL.Mem), CXL for PCIe-based I/O devices (CXL.IO/PCIe®), etc.).

In the illustrated example of FIG. 1, the boot drive 104 is implemented by a non-volatile memory (NVM) such as a solid-state drive (SSD), read-only memory (ROM), erasable programmable ROM (EPROM), electrically erasable programmable ROM (EEPROM), and/or flash memory, among others. In the example of FIG. 1, the boot drive 104 is implemented in accordance with the NVMe specification. In some examples, the boot drive 104 is implemented in accordance with an additional or alternative specification (e.g., a Serial Advanced Technology Attachment (SATA) specification, a serial attached SCSI (SAS) specification, an advanced host controller interface (AHCI) specification, the PCIe specification, a Fibre Channel specification, a universal flash storage (UFS) specification, etc.). In some examples, the boot drive 104 has a form factor in accordance with a U.2 specification a U.2 specification (e.g., an SSD Form Factor-8639 (SFF-8639) specification) or an M.2 specification.

In the illustrated example of FIG. 1, the boot drive 104 includes a physical memory controller 110. In the example of FIG. 1, the physical memory controller 110 controls the PF of the boot drive 104. For example, the PF of the boot drive 104 is the primary function of the boot drive 104 (e.g., to store data). In the example of FIG. 1, the physical memory controller 110 is implemented by an integrated circuit housed in the boot drive 104.

In the illustrated example of FIG. 1, the partition manager circuitry 102 interacts with the physical memory controller 110 (e.g., over the interface 108) to partition the boot drive 104 into a first example namespace 112_{A}, a second example namespace 112_{B}, a third example namespace 112_{C}, and a fourth example namespace 112_{D}. For example, the partition manager circuitry 102 accesses a system configuration for the compute device 100 to determine a number of namespaces into which the boot drive 104 is to be partitioned.

In the illustrated example of FIG. 1, the partition manager circuitry 102 causes the physical memory controller 110 to create the first namespace 112_{A}, the second namespace 112_{B}, the third namespace 112_{C}, and the fourth namespace 112_{D}. In the example of FIG. 1, the first namespace 112_{A} is a first address range in the boot drive 104 that is reserved for a first purpose specified in the system configuration. Also, the second namespace 112_{B} is a second address range in the boot drive 104 that is reserved for a second purpose specified in the system configuration. In the example of FIG. 1, the third namespace 112_{C} is a third address range in the boot drive 104 that is reserved for a third purpose specified in the system configuration. Also, the fourth namespace 112_{D} is a fourth address range in the boot drive 104 that is reserved for a fourth purpose specified in the system configuration.

In the illustrated example of FIG. 1, the partition manager circuitry 102 associates the first namespace 112_{A}, the second namespace 112_{B}, the third namespace 112_{C}, and the fourth namespace 112_{D} with the PF and/or one or more VFs of the boot drive 104 based on the system configuration. As described above, the PF of the boot drive 104 is the primary function of the boot drive 104 (e.g., to store data). In the example of FIG. 1, a VF of the boot drive 104 is associated with the PF of the boot drive 104. For example, a VF of the boot drive 104 is a virtualized instance of one or more physical resources of the boot drive. 104. In the example of FIG. 1, the one or more VFs of the boot drive 104 include a first example virtual memory controller 114 (e.g., VF 1) and a second example virtual memory controller 116 (e.g., VF 2).

In the illustrated example of FIG. 1, the partition manager circuitry 102 associates the first namespace 112_{A} with the physical memory controller 110 based on the system configuration. In the example of FIG. 1, the partition manager circuitry 102 associates the second namespace 112_{B} with the first virtual memory controller 114 based on the system configuration. Also, the partition manager circuitry 102 associates the third namespace 112_{C} with the second virtual memory controller 116 based on the system configuration. In the example of FIG. 1, the partition manager circuitry 102 associates the fourth namespace 112_{D} with the physical memory controller 110 and the first virtual memory controller 114 based on the system configuration. In this manner, the fourth namespace 112_{D} is a shared namespace.

In the illustrated example of FIG. 1, the partition manager circuitry 102 also associates the first virtual memory controller 114 with the second processor circuit 106_{B} and associates the second virtual memory controller 116 with the third processor circuit 106_{C}. In the example of FIG. 1, the first processor circuit 106_{A} is already associated with the physical memory controller 110, for example, because the first processor circuit 106_{A} has been designated control over the PF of the boot drive 104 via the trusted VF of the partition manager circuitry 102.

As such, each of the first processor circuit 106_{A}, the second processor circuit 106_{B}, and the third processor circuit 106_{C} can communicate independently with the boot drive 104 via the interface 108. For example, the first processor circuit 106_{A} communicates with the boot drive 104 via a first example channel 118A with the physical memory controller 110. Also, for example, the second processor circuit 106_{B} communicates with the boot drive 104 via a second example channel 118B with the first virtual memory controller 114. In the example of FIG. 1, the third processor circuit 106_{C} communicates with the boot drive 104 via a third example channel 118_{C} with the second virtual memory controller 116.

As described above, the partition manager circuitry 102 configures the boot drive 104 to present one or more virtual memory controllers (e.g., the first virtual memory controller 114, the second virtual memory controller 116, etc.) to peer processor circuits (e.g., the second processor circuit 106_{B}, the third processor circuit 106_{C}, etc.) of the compute device 100. For example, the partition manager circuitry 102 utilizes single root I/O virtualization (SR-IOV) to present one or more virtual memory controllers to peer processor circuits of the compute device 100. In some examples, the partition manager circuitry 102 utilizes scalable I/O virtualization (S-IOV) to facilitate greater scalability (e.g., in an example where the boot drive 104 is disaggregated over a CXL interface).

Additionally, the partition manager circuitry 102 attaches partitioned namespaces of the boot drive 104 to virtual memory controllers (e.g., via the NVMe namespace attach feature) and attaches the virtual memory controllers to one or more processor circuits of the compute device 100. In some examples, the partition manager circuitry 102 assigns different levels of service level agreements (SLAs) to each namespace of the boot drive 104. In this manner, the partition manager circuitry 102 can control how much bandwidth of the interface 108 each of the attached processor circuits can access during boot time. For example, at boot time, certain processor circuits are assigned a large amount of bandwidth (e.g., high priority) of the interface 108.

As described above, each processor circuit of the compute device is associated with its own partition of the boot drive 104. In some examples, as described above, the partition manager circuitry 102 sets up shared namespaces for data sharing between two or more processor circuits of the compute device 100. Thus, different processor circuits of the compute device 100 can manage their own partitions (e.g., in terms of partition layout, file system type, etc.) in a way that is appropriate for the designated tasks of the processor circuits. Accordingly, peer processor circuits of the compute device 100 have direct access to the boot drive 104 and can employ unique storage policies such as selecting an appropriate block size (e.g., a size of a single unit of storage) for respective namespaces in the boot drive 104. In this way, the partition manager circuitry 102 parallelizes access to and management of a single boot drive by multiple processor circuits.

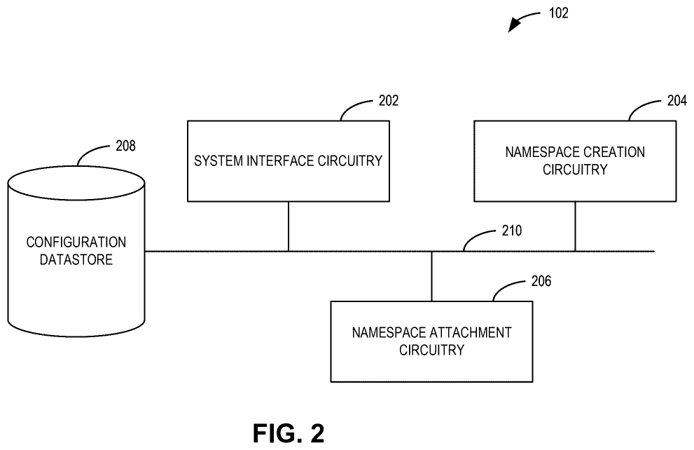

FIG. 2 is a block diagram of an example implementation of the partition manager circuitry 102 of FIG. 1. The partition manager circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the partition manager circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the partition manager circuitry 102 includes example system interface circuitry 202, example namespace creation circuitry 204, example namespace attachment circuitry 206, and an example configuration datastore 208. In the example of FIG. 2, one or more of the system interface circuitry 202, the namespace creation circuitry 204, the namespace attachment circuitry 206, and the configuration datastore 208 are in communication via an example communication bus 210. For example, the communication bus 210 is implemented by at least one of an Inter-Integrated Circuit (I2C) bus, an SPI bus, a PCI bus, or a PCIe bus. Additionally or alternatively, the communication bus 210 is implemented by any other type of computing or electrical bus.

In the illustrated example of FIG. 2, the system interface circuitry 202 acts as an interface between the partition manager circuitry 102 and the compute device 100. For example, the system interface circuitry 202 facilitates communication between the partition manager circuitry 102 and the physical memory controller 110. In the example of FIG. 2, the system interface circuitry 202 retrieves system configuration information. For example, the system interface circuitry 202 accesses system configuration information from local memory of the compute device 100. In some examples, the system interface circuitry 202 polls the compute device 100 to discover one or more components of the compute device (e.g., the boot drive 104, the first processor circuit 106_{A}, the second processor circuit 106_{B}, the third processor circuit 106_{C}, etc.). Additionally or alternatively, the system interface circuitry 202 accesses system configuration information from an external device (e.g., another compute device) and/or as an input from a user.

In the illustrated example of FIG. 2, the system interface circuitry 202 stores (e.g., causes storage of) the system configuration information in the configuration datastore 208. In the example of FIG. 2, system configuration information may be set up in advance and be user specific, influenced by specific hardware setup. Also, in the example of FIG. 2, system configuration information includes a number of namespaces to be created in the boot drive 104 and respective sizes of the namespaces to be created in the boot drive 104. Additionally, system configuration information includes whether the namespaces are to be shared namespaces or exclusively managed by one memory controller and identities of processor circuits in the compute device 100 that are to manage any shared namespaces to be created in the boot drive 104.

In the illustrated example of FIG. 2, system configuration information includes a mapping of each processor circuit of the compute device 100 with exclusive namespaces managed by the processor circuits and a mapping of shared namespace(s) to two or more processor circuits that are to share data stored in the shared namespace(s). In the example of FIG. 2, system configuration information also includes the identities of the processor circuits of the compute device 100 (e.g., the first processor circuit 106_{A}. the second processor circuit 106_{B}, and the third processor circuit 106_{C}). Based on directives of the system configuration information, the partition manager circuitry 102 sets up and configures the boot drive 104 (e.g., an NVM boot drive, an NVMe boot drive, etc.) and the compute device 100 (e.g., a PCIe system, a CXL system, etc.).

In the illustrated example of FIG. 2, based on the system configuration information, the namespace creation circuitry 204 determines at least one parameter of a namespace to be configured for the boot drive 104. For example, parameters of a namespace include a size of the namespace, a mapping of the namespace to a processor circuit that is to manage the namespace, and other parameters of the system configuration information described above. Based on the at least one parameter, the namespace creation circuitry 204 causes the physical memory controller 110 to create a namespace in the boot drive 104 via the system interface circuitry 202.

In the illustrated example of FIG. 2, the namespace creation circuitry 204 causes the physical memory controller 110 to create a namespace for each processor circuit or group of processor circuits (e.g., a cluster) that is to execute a different OS on the compute device 100. In the example of FIG. 2, the namespace attachment circuitry 206 attaches each of the namespaces to a memory controller of the boot drive 104. For example, the namespace attachment circuitry 206 interfaces with the physical memory controller 110 via the system interface circuitry 202 to attach each of the namespaces of the boot drive 104 to a memory controller (e.g., physical or virtual) of the boot drive 104.

In the illustrated example of FIG. 2, the namespace creation circuitry 204 can also attach one or more shared namespaces created in the boot drive 104 to two or more memory controllers of the boot drive 104. In the example of FIG. 2, the system interface circuitry 202 attaches the memory controllers of the boot drive 104 to the processor circuits of the compute device 100 (e.g., via S-IOV, via SR-IOV, etc.). As such, the partition manager circuitry 102 configures the compute device 100 so that each of the processor circuits 106 can access the boot drive 104 directly though their own boot drive driver stack.

Based on example configuration described herein, each of the processor circuits 106 has visibility to the assigned namespace and does not have visibility to the namespace of any other peer processor circuit. As described above, the partition manager circuitry 102 can configure one or more shared namespaces in the boot drive 104 to set up shared access to a portion of the boot drive 104. With example configuration described herein, each of the processor circuits 106 has full autonomy over the block layout of its assigned namespace. As such, each of the processor circuits 106 can individually decide to partition their namespaces as desired (e.g., creating their own extensible firmware interface (EFI) boot partition).

In some examples, one or more of the system interface circuitry 202, the namespace creation circuitry 204, or the namespace attachment circuitry 206 is implemented by a Linux kernel that is configured as a trusted VF such that the first processor circuit 106_{A} can act as an administrator of the compute device 100. In such examples, the trusted VF Linux kernel is given access to perform administrative configuration of the compute device 100 (e.g., at a PF level). As such, the boot drive 104 can be administered by a remote processor circuit (e.g., a processor circuit in a different physical location than the boot drive 104). Thus, multiple instances of an AMP, such as an IPU, can simultaneously connect to a single boot drive.

In the illustrated example of FIG. 2, the configuration datastore 208 records data (e.g., system configuration information as described above). The configuration datastore 208 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The configuration datastore 208 may additionally or alternatively be implemented by one or more double data rate (DDR) memories, such as DDR, DDR2, DDR3, DDR4, DDR5, mobile DDR (mDDR), DDR SDRAM, etc.

In the illustrated example of FIG. 2, the configuration datastore 208 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the configuration datastore 208 is illustrated as a single datastore, the configuration datastore 208 may be implemented by any number and/or type(s) of datastores. Furthermore, the data stored in the configuration datastore 208 may be in any data format such as, for example, binary data, comma delimited data, tab delimited data, structured query language (SQL) structures, etc.

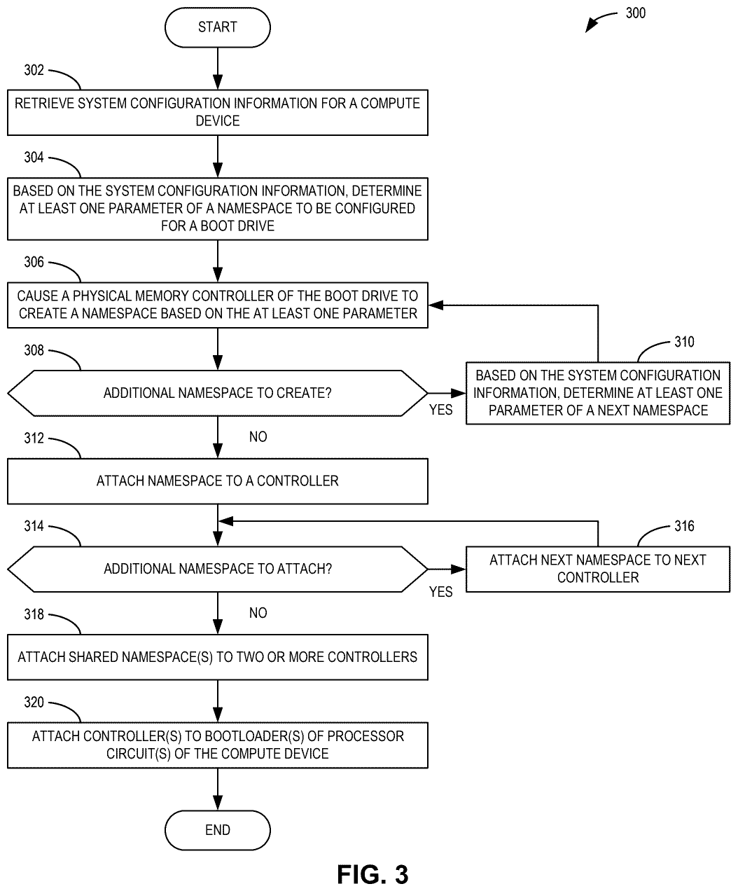

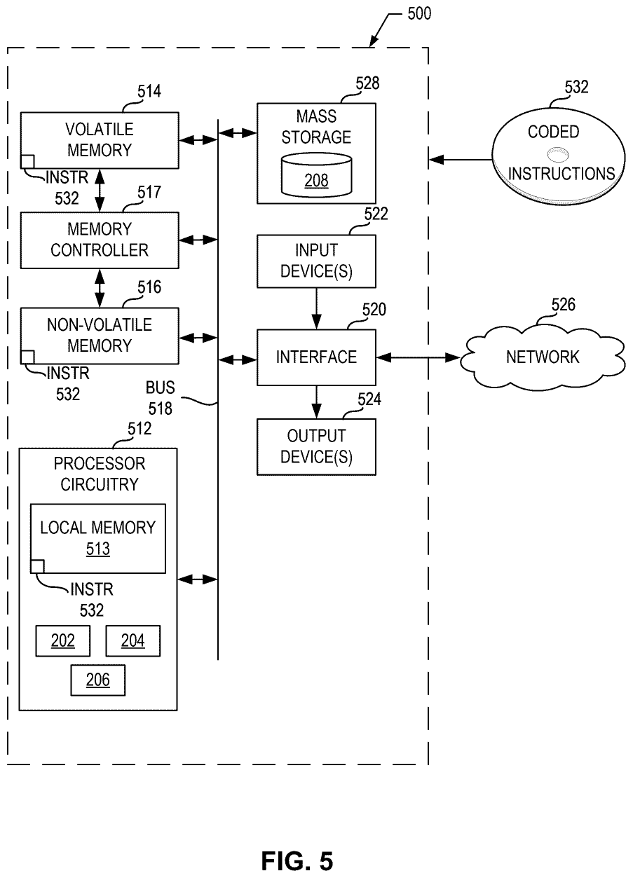

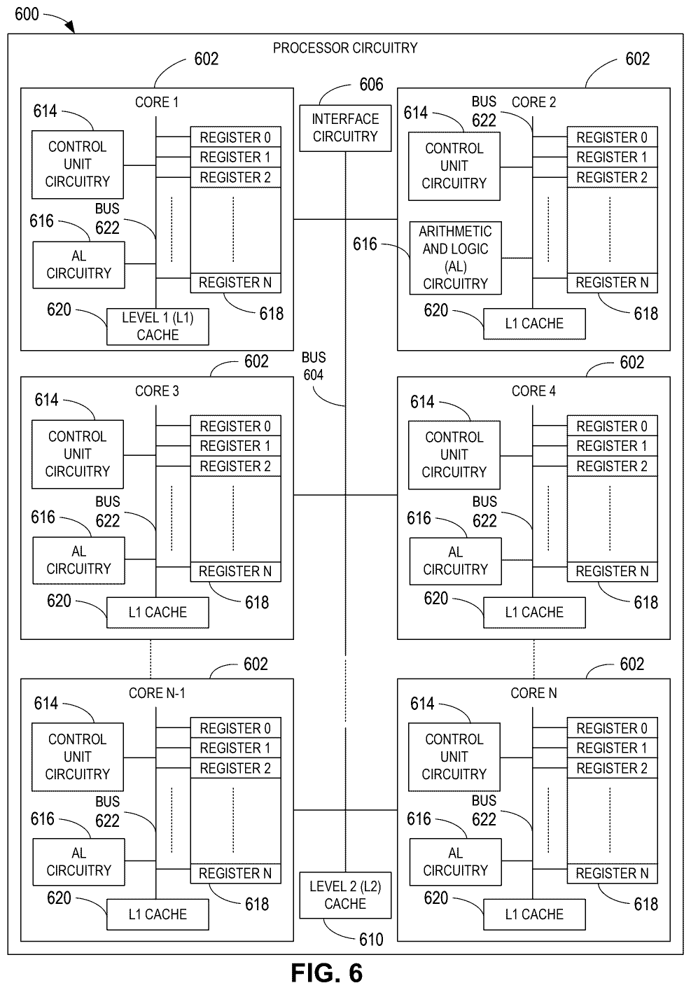

In some examples, the system interface circuitry 202 is instantiated by programmable circuitry executing system interfacing instructions and/or configured to perform operations such as those represented by the flowchart(s) of FIG. 3. In some examples, the partition manager circuitry 102 includes means for interfacing with a device. For example, the means for interfacing may be implemented by the system interface circuitry 202. In some examples, the system interface circuitry 202 may be instantiated by programmable circuitry such as the example programmable circuitry 512 of FIG. 5. For instance, the system interface circuitry 202 may be instantiated by the example microprocessor 600 of FIG. 6 executing machine-executable instructions such as those implemented by at least blocks 302 and 320 of FIG. 3.

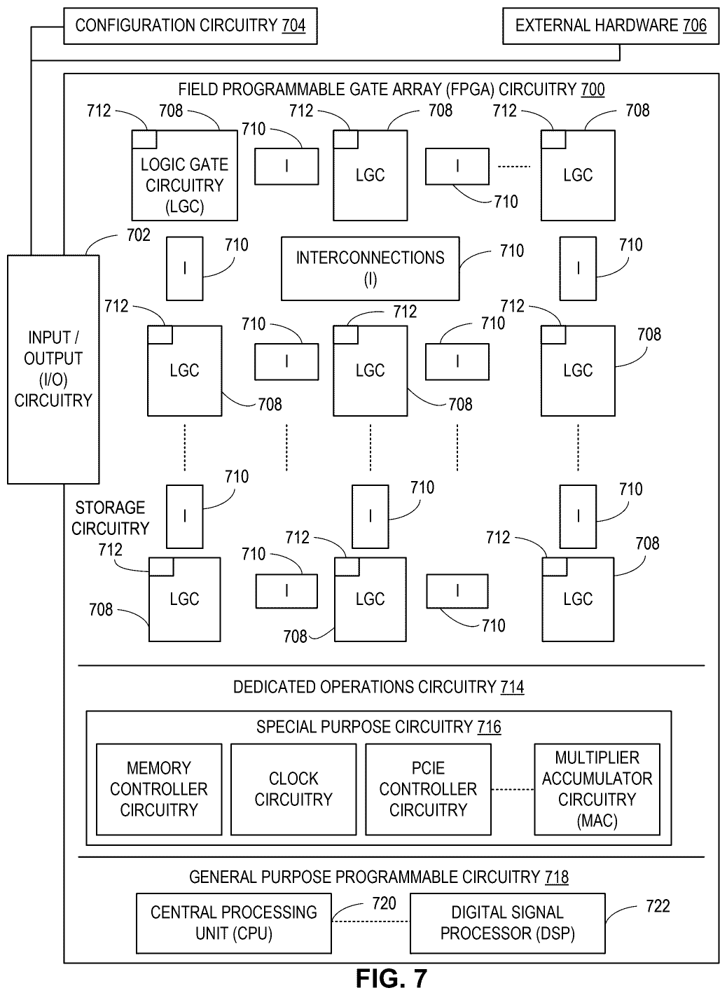

In some examples, the system interface circuitry 202 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the system interface circuitry 202 may be instantiated by any other combination of hardware, software, and/or firmware. For example, the system interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the namespace creation circuitry 204 is instantiated by programmable circuitry executing namespace creation instructions and/or configured to perform operations such as those represented by the flowchart(s) of FIG. 3. In some examples, the partition manager circuitry 102 includes means for creating a namespace in memory. For example, the means for creating may be implemented by the namespace creation circuitry 204. In some examples, the namespace creation circuitry 204 may be instantiated by programmable circuitry such as the example programmable circuitry 512 of FIG. 5. For instance, the namespace creation circuitry 204 may be instantiated by the example microprocessor 600 of FIG. 6 executing machine-executable instructions such as those implemented by at least blocks 304, 306, 308, and 310 of FIG. 3.

In some examples, the namespace creation circuitry 204 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the namespace creation circuitry 204 may be instantiated by any other combination of hardware, software, and/or firmware. For example, the namespace creation circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the namespace attachment circuitry 206 is instantiated by programmable circuitry executing namespace attachment instructions and/or configured to perform operations such as those represented by the flowchart(s) of FIG. 3. In some examples, the partition manager circuitry 102 includes means for attaching a namespace to a controller. For example, the means for attaching may be implemented by namespace attachment circuitry 206. In some examples, the namespace attachment circuitry 206 may be instantiated by programmable circuitry such as the example programmable circuitry 512 of FIG. 5. For instance, the namespace attachment circuitry 206 may be instantiated by the example microprocessor 600 of FIG. 6 executing machine-executable instructions such as those implemented by at least blocks 312, 314, 316, and 318 of FIG. 3.

In some examples, the namespace attachment circuitry 206 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the namespace attachment circuitry 206 may be instantiated by any other combination of hardware, software, and/or firmware. For example, the namespace attachment circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the partition manager circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example system interface circuitry 202, the example namespace creation circuitry 204, the example namespace attachment circuitry 206, the example configuration datastore 208, and/or, more generally, the example partition manager circuitry 102 of FIG. 2, may be implemented by hardware alone or by hardware in combination with software and/or firmware. Thus, for example, any of the example system interface circuitry 202, the example namespace creation circuitry 204, the example namespace attachment circuitry 206, the example configuration datastore 208, and/or, more generally, the example partition manager circuitry 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example partition manager circuitry 102 of FIG. 2 may include one or more elements, processes, and/or devices in addition to, or instead of, those illustrated in FIG. 2, and/or may include more than one of any or all of the illustrated elements, processes, and devices.

A flowchart representative of example machine-readable instructions, which may be executed by programmable circuitry to implement and/or instantiate the partition manager circuitry 102 of FIG. 2 and/or representative of example operations which may be performed by programmable circuitry to implement and/or instantiate the partition manager circuitry 102 of FIG. 2, is shown in FIG. 3. The machine-readable instructions may be one or more executable programs or portion(s) of one or more executable programs for execution by programmable circuitry such as the programmable circuitry 512 shown in the example programmable circuitry platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 3, many other methods of implementing the example partition manager circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by example programmable circuitry to implement the partition manager circuitry 102 of FIG. 2. The example machine-readable instructions and/or the example operations 300 of FIG. 3 begin at block 302, at which the system interface circuitry 202 retrieves system configuration information for a compute device. For example, the system interface circuitry 202 accesses system configuration information from local memory of the compute device 100, polls the compute device 100 to determine the system configuration information, and/or accesses the system configuration information from an external device (e.g., another compute device) and/or as an input from a user.

In the illustrated example of FIG. 3, at block 304, based on the system configuration information, the namespace creation circuitry 204 determines at least one parameter of a namespace to be configured for a boot drive (e.g., the boot drive 104). In the example of FIG. 3, at block 306, the namespace creation circuitry 204 causes a physical memory controller of the boot drive to create a namespace in the boot drive based on the at least one parameter. At block 308, the namespace creation circuitry 204 determines if there is an additional namespace to create. Based on (e.g., in response to) the namespace creation circuitry 204 determining that there is an additional namespace to create (block 308: YES), the machine-readable instructions and/or the operations 300 proceed to block 310.

In the illustrated example of FIG. 3, at block 310, based on the system configuration information, the namespace creation circuitry 204 determines at least one parameter of a next namespace to be configured for a boot drive (e.g., the boot drive 104). After block 310, the machine-readable instructions and/or the operations 300 return to block 306. Returning to block 308, based on (e.g., in response to) the namespace creation circuitry 204 determining that there is not an additional namespace to create (block 308: NO), the machine-readable instructions and/or the operations 300 proceed to block 312.

In the illustrated example of FIG. 3, at block 312, the namespace attachment circuitry 206 attaches a namespace to a controller. For example, the namespace attachment circuitry 206 attaches a first namespace to a physical memory controller of the boot drive. At block 314, the namespace attachment circuitry 206 determines if there is an additional namespace to attach. Based on (e.g., in response to) the namespace attachment circuitry 206 determining that there is an additional namespace to attach (block 314: YES), the machine-readable instructions and/or the operations 300 proceed to block 316.

In the illustrated example of FIG. 3, at block 316, based on the system configuration information, the namespace attachment circuitry 206 attaches a next namespace to a next controller. For example, the namespace attachment circuitry 206 attaches a second namespace to a virtual memory controller of the boot drive. After block 316, the machine-readable instructions and/or the operations 300 return to block 314. Returning to block 314, based on (e.g., in response to) the namespace attachment circuitry 206 determining that there is not an additional namespace to attach (block 316: NO), the machine-readable instructions and/or the operations 300 proceed to block 318.

In the illustrated example of FIG. 3, at block 318, the namespace attachment circuitry 206 attaches a shared namespace to two or more controllers (e.g., physical and/or virtual) of the boot drive. In the example of FIG. 3, the namespace attachment circuitry 206 may repeat block 318 for the number of shared namespaces designated by the system configuration information retrieved at block 302. At block 320, the system interface circuitry 202 attaches the controllers (e.g., physical and/or virtual) of the boot drive to bootloaders of processor circuits of the compute device.

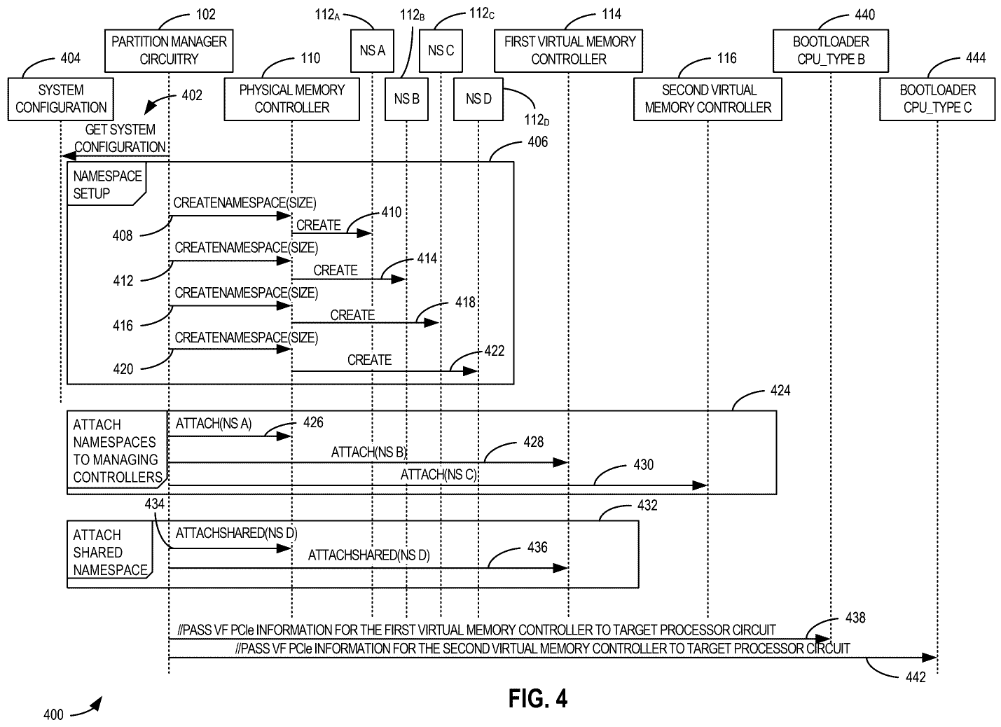

FIG. 4 is a sequence diagram illustrating example communication 400 between the partition manager circuitry 102 and other components of the compute device 100 of FIG. 1 to initialize the boot drive 104 of FIG. 1. In the illustrated example of FIG. 4, the communications 400 can be executed during Day-0 of the compute device 100. For example, Day-0 refers to the initial day of deployment of the compute device 100 and the communications 400 can be implemented as part of the overall boot sequence of the compute device 100.

In the illustrated example of FIG. 4, at communication 402, the partition manager circuitry 102 gets a system configuration 404 (e.g., system configuration information as described herein). For example, the partition manager circuitry 102 accesses the system configuration 404 from local memory of the compute device 100, polls the compute device 100 to determine the system configuration 404, and/or accesses the system configuration 404 from an external device (e.g., another compute device) and/or as an input from a user. In the example of FIG. 4, the system configuration 404 describes how the boot drive 104 should be divided among the processor circuits 106.

In the illustrated example of FIG. 4, in an example namespace setup phase 406, at communication 408, the partition manager circuitry 102 causes the physical memory controller 110 to create the first namespace 112_{A} in the boot drive 104 based on at least one parameter identified in the system configuration 404. For example, the partition manager circuitry 102 instructs the physical memory controller 110 to create the first namespace 112_{A} according to the at least one parameter identified in the system configuration 404. In the example of FIG. 4, the at least one parameter identified in the system configuration 404 includes a size for the first namespace 112_{A}. In the example of FIG. 4, at communication 410, the physical memory controller 110 creates the first namespace 112_{A} based on the at least one parameter received from the partition manager circuitry 102.

In the illustrated example of FIG. 4, at communication 412, the partition manager circuitry 102 causes the physical memory controller 110 to create the second namespace 112_{B} in the boot drive 104 based on at least one parameter identified in the system configuration 404. At communication 414, the physical memory controller 110 creates the second namespace 112_{B} based on the at least one parameter received from the partition manager circuitry 102. In the example of FIG. 4, at communication 416, the partition manager circuitry 102 causes the physical memory controller 110 to create the third namespace 112_{C} in the boot drive 104 based on at least one parameter identified in the system configuration 404. At communication 418, the physical memory controller 110 creates the third namespace 112_{C} based on the at least one parameter received from the partition manager circuitry 102.

In the illustrated example of FIG. 4, at communication 420, the partition manager circuitry 102 causes the physical memory controller 110 to create the fourth namespace 112_{D} (e.g., a shared namespace) in the boot drive 104 based on at least one parameter identified in the system configuration 404. At communication 422, the physical memory controller 110 creates the fourth namespace 112_{D} based on the at least one parameter received from the partition manager circuitry 102. In the example of FIG. 4, in an example namespace attach phase 424, the partition manager circuitry 102 sets up the VFs for each memory controller that is designated for each of the processor circuits 106 according to the system configuration 404. Once configured, each of the namespaces is associated with and bound to the memory controllers.

For example, at communication 426 of the namespace attach phase 424, the partition manager circuitry 102 attaches the first namespace 112_{A} to the physical memory controller 110. At communication 428, the partition manager circuitry 102 attaches the second namespace 112_{B} to the first virtual memory controller 114. At communication 420, the partition manager circuitry 102 attaches the third namespace 112_{C} to the second virtual memory controller 116. In the example of FIG. 4, in an example shared namespace attach phase 432, the partition manager circuitry 102 assigns any shared namespaces created in the namespace setup phase 406 to two more memory controllers of the boot drive 104.

For example, at communication 434, the partition manager circuitry 102 attaches the fourth namespace 112_{D} to the physical memory controller 110. At communication 436, the partition manager circuitry 102 also attaches the fourth namespace 112_{D} to the first virtual memory controller 114. In the example of FIG. 4, after the namespace setup phase 406, the namespace attach phase 424, and the shared namespace attach phase 432, the boot drive 104 is setup for usage and there is PCIe configuration to access the physical memory controller 110, the first virtual memory controller 114, and the second virtual memory controller 116 over the interface 108.

Additionally, after the namespace setup phase 406, the namespace attach phase 424, and the shared namespace attach phase 432, the partition manager circuitry 102 communicates PCIe configuration for each virtualized instance of the physical memory controller 110 to bootloaders of one or more of the processor circuits 106 as designated by the system configuration 404. As such the bootloaders of the processor circuits 106 can begin running and controlling the OS to be booted from the respective namespaces of the boot drive 104.

For example, at communication 438, the partition manager circuitry 102 communicates the PCIe configuration information for the first virtual memory controller 114 to a first example bootloader 440 of the second processor circuit 106_{B}. Additionally, at communication 442, the partition manager circuitry 102 communicates the PCIe configuration information for the second virtual memory controller 116 to a second example bootloader 444 of the third processor circuit 106_{C}. In some examples, one or more of the first bootloader 440 or the second bootloader 444 is an in-memory, pre-boot execution environment (PXE) loaded OS that is responsible for configuring the assigned virtual controller with a desired partition structure and filesystem. As such, by communicating the PCIe configuration information for the first virtual memory controller 114 and the second virtual memory controller 116 to the first bootloader 440 and the second bootloader 444, respectively, the partition manager circuitry 102 cause the second processor circuit 106_{B} and the third processor circuit 106_{C}, respectively, to load the first bootloader 440 and the second bootloader 444 in respective PXEs.

As described herein, implementing the partition manager circuitry 102 mitigates the use of a centralized provisioning manager that is responsible for both (1) understanding the compute environment of the compute device 100 and (2) taking responsibility for ensuring that the OSes of peer processor circuits are provisioned as desired. For example, in other examples, a compute device includes a designated leader processor circuit that takes management of the lifecycle of other peer processor circuits. In such examples, the designated leader processor circuit has detailed knowledge of the filesystem selection and partition construction of peer processor circuits in advance of installation.

Additionally, if more than one OS is to leverage an EFI partition, the complexity of interfacing between the designated leader processor circuit and bootloaders of peer processor circuits is increased. For example, complexity of interfacing between the designated leader processor circuit and bootloaders of peer processor circuits is increased to determine which EFI partitions correspond to which bootloaders and which EFI partitions the bootloaders should disregard. Also, in other examples, post-install of OSes to peer processor circuits, a leader processor circuit operates as a gateway to proxy interactions with the boot drive. Such proxied communications increase the complexity of software stacks on both the leader processor circuit as well as peer processor circuits while also impeding I/O performance as direct access to the boot drive is funneled through the leader processor circuit.

Unlike other examples, disclosed methods, apparatus, and articles of manufacture assign management of the lifecycle of a processor circuit to that processor circuit. As such, multiple processor circuits can share a single boot drive, while increasing (e.g., maximizing) independence on how each processor circuit can use the single boot drive. For example, post-configuration of the boot drive 104, each of the processor circuits 106 manages installation of its own OS and post-install of the OSes, each of the processor circuits 106 can access the boot drive 104 independently.

FIG. 5 is a block diagram of an example programmable circuitry platform 500 structured to execute and/or instantiate the example machine-readable instructions and/or the example operations of FIG. 3 to implement the partition manager circuitry 102 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the example system interface circuitry 202, the example namespace creation circuitry 204, and the example namespace attachment circuitry 206.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the one or more mass storage discos or devices 528 implements the example configuration datastore 208.

The machine-readable instructions 532, which may be implemented by the machine-readable instructions of FIG. 3, may be stored in the mass storage device 528, in the volatile memory 514, in the non-volatile memory 516, and/or on at least one non-transitory computer-readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowchart of FIG. 3 to effectively instantiate the circuitry of FIG. 2 as logic circuits to perform operations corresponding to those machine-readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine-readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine-readable instructions and/or operations represented by the flowchart of FIG. 3.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry 616 (sometimes referred to as an ALU), a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer-based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine-readable instructions. However, once configured, the FPGA circuitry 700 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine-readable instructions represented by the flowchart(s) of FIG. 3 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIG. 3. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 700 may be configured and/or structured to effectively instantiate some or all of the operations/functions corresponding to the machine-readable instructions of the flowchart(s) of FIG. 3 as dedicated logic circuits to perform the operations/functions corresponding to those software instructions in a dedicated manner analogous to an ASIC. Therefore, the FPGA circuitry 700 may perform the operations/functions corresponding to the some or all of the machine-readable instructions of FIG. 3 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine-readable instructions of FIG. 3 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine-readable instructions represented by the flowchart(s) of FIG. 3 to perform first operation(s)/function(s), the FPGA circuitry 700 of FIG. 7 may be configured and/or structured to perform second operation(s)/function(s) corresponding to a second portion of the machine-readable instructions represented by the flowchart of FIG. 3, and/or an ASIC may be configured and/or structured to perform third operation(s)/function(s) corresponding to a third portion of the machine-readable instructions represented by the flowchart of FIG. 3.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine-readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

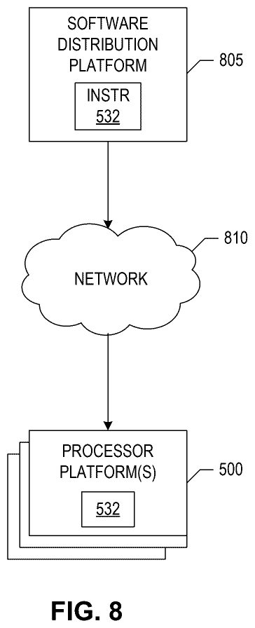

A block diagram illustrating an example software distribution platform 805 to distribute software such as the example machine-readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine-readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine-readable instructions 532, which may correspond to the example machine-readable instructions of FIG. 3, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 532 from the software distribution platform 805. For example, the software, which may correspond to the example machine-readable instructions of FIG. 3, may be downloaded to the example programmable circuitry platform 500, which is to execute the machine-readable instructions 532 to implement the partition manager circuitry 102. In some examples, one or more servers of the software distribution platform 805 periodically offer, transmit, and/or force updates to the software (e.g., the example machine-readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that facilitate an NVMe boot drive as a service. For example, disclosed examples include efficient and secure sharing of an NVMe boot drive amongst multiple processor circuits (e.g., in an IPU, AMP, DPU, etc.). As such, example systems, apparatus, articles of manufacture, and methods disclosed herein increase the performance of a compute device having a hybrid architecture by allowing each processor circuit of the compute device to directly access a boot drive via its own dedicated channel with the boot drive. Thus, disclosed examples facilitate NVMe parallelism, threading, and/or streaming.

Additionally, by avoiding the use of a leader processor circuit, examples disclosed herein reduce the complexity of software stacks of processor circuits as each processor circuit manages its respective software installation and lifecycle management and does not have to track the software installation and/or lifecycle management of other processor circuits. Disclosed systems, apparatus, articles of manufacture, and methods improve the efficiency of using a computing device by reducing the power consumption of a compute device. For example, by reducing the number of boot drives to implement multiple processor circuits in a hybrid architecture compute device, examples disclosed herein reduce power consumption of the compute device. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to partition a boot drive for two or more processor circuits are disclosed herein. Further examples and combinations thereof include the following:

Example 1 includes at least one non-transitory machine-readable storage medium comprising instructions to cause at least one first processor circuit to at least determine at least one first parameter for a first namespace and at least one second parameter for a second namespace to be configured for a non-volatile memory (NVM) boot drive, cause a first controller of the NVM boot drive to create the first namespace based on the at least one first parameter, the first controller associated with a physical function of the NVM boot drive, cause the first controller to create the second namespace based on the at least one second parameter, attach the first namespace to the first controller of the NVM boot drive, attach the second namespace to a second controller of the NVM boot drive, the second controller associated with a virtual function of the NVM boot drive, and attach the second controller to a bootloader of a second processor circuit.

Example 2 includes the at least one non-transitory machine-readable storage medium of example 1, wherein the first controller is associated with the at least one first processor circuit.

Example 3 includes the at least one non-transitory machine-readable storage medium of example 2, wherein the at least one first processor circuit and the second processor circuit are different types of processor circuits.

Example 4 includes the at least one non-transitory machine-readable storage medium of any of examples 1 or 2, wherein the instructions cause one or more of the at least one first processor circuit to cause the first controller to create a shared namespace based on at least one third parameter, and attach the shared namespace to the first controller and the second controller.

Example 5 includes the at least one non-transitory machine-readable storage medium of any of examples 1, 2, or 4, wherein the virtual function is a first virtual function of the NVM boot drive, and the instructions cause one or more of the at least one first processor circuit to cause the first controller to create a third namespace based on at least one third parameter, and attach the third namespace to a third controller of the NVM boot drive, the third controller associated with a second virtual function of the NVM boot drive.

Example 6 includes the at least one non-transitory machine-readable storage medium of any of examples 1, 2, 4, or 5, wherein the at least one second parameter includes a size for the second namespace and an indication of a mapping of the second namespace to the second processor circuit.

Example 7 includes the at least one non-transitory machine-readable storage medium of any of examples 1, 2, 4, 5, or 6, wherein the instructions cause one or more of the at least one first processor circuit to cause the second processor circuit to load the bootloader in a pre-boot execution environment.

Example 8 includes an apparatus comprising interface circuitry, machine-readable instructions, and at least one first processor circuit to utilize the machine-readable instructions to determine at least one first parameter for a first namespace and at least one second parameter for a second namespace to be configured for a non-volatile memory (NVM) boot drive, cause a first controller of the NVM boot drive to create the first namespace based on the at least one first parameter, the first controller associated with a physical function of the NVM boot drive, cause the first controller to create the second namespace based on the at least one second parameter, attach the first namespace to the first controller of the NVM boot drive, attach the second namespace to a second controller of the NVM boot drive, the second controller associated with a virtual function of the NVM boot drive, and attach the second controller to a bootloader of a second processor circuit.

Example 9 includes the apparatus of example 8, wherein the first controller is associated with the at least one first processor circuit.

Example 10 includes the apparatus of example 9, wherein the at least one first processor circuit and the second processor circuit are different types of processor circuits.

Example 11 includes the apparatus of any of examples 8 or 9, wherein one or more of the at least one first processor circuit is to cause the first controller to create a shared namespace based on at least one third parameter, and attach the shared namespace to the first controller and the second controller.

Example 12 includes the apparatus of any of examples 8, 9, or 11, wherein the virtual function is a first virtual function of the NVM boot drive, and one or more of the at least one first processor circuit is to cause the first controller to create a third namespace based on at least one third parameter, and attach the third namespace to a third controller of the NVM boot drive, the third controller associated with a second virtual function of the NVM boot drive.

Example 13 includes the apparatus of any of examples 8, 9, 11, or 12, wherein the at least one second parameter includes a size for the second namespace and an indication of a mapping of the second namespace to the second processor circuit.

Example 14 includes the apparatus of any of examples 8, 9, 11, 12, or 13, wherein one or more of the at least one first processor circuit is to cause the second processor circuit to load the bootloader in a pre-boot execution environment.

Example 15 includes a method comprising determining at least one first parameter for a first namespace and at least one second parameter for a second namespace to be configured for a non-volatile memory (NVM) boot drive, causing a first controller of the NVM boot drive to create the first namespace based on the at least one first parameter, the first controller associated with a physical function of the NVM boot drive, causing the first controller to create the second namespace based on the at least one second parameter, attaching the first namespace to the first controller of the NVM boot drive, attaching the second namespace to a second controller of the NVM boot drive, the second controller associated with a virtual function of the NVM boot drive, and attaching, by executing at least one instruction with at least one first processor circuit, the second controller to a bootloader of a second processor circuit.

Example 16 includes the method of example 15, wherein the first controller is associated with the at least one first processor circuit.

Example 17 includes the method of example 16, wherein the at least one first processor circuit and the second processor circuit are different types of processor circuits.

Example 18 includes the method of any of examples 15 or 17, further including causing the first controller to create a shared namespace based on at least one third parameter, and attaching the shared namespace to the first controller and the second controller.

Example 19 includes the method of any of examples 15, 17, or 18, wherein the virtual function is a first virtual function of the NVM boot drive, and the method further includes causing the first controller to create a third namespace based on at least one third parameter, and attaching the third namespace to a third controller of the NVM boot drive, the third controller associated with a second virtual function of the NVM boot drive.

Example 20 includes the method of any of examples 15, 17, 18, or 19, wherein the at least one second parameter includes a size for the second namespace and an indication of a mapping of the second namespace to the second processor circuit.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable storage medium comprising instructions to cause at least one first processor circuit to at least:
determine at least one first parameter for a first namespace and at least one second parameter for a second namespace to be configured for a non-volatile memory (NVM) boot drive;
cause a first controller of the NVM boot drive to create the first namespace based on the at least one first parameter, the first controller associated with a physical function of the NVM boot drive;
cause the first controller to create the second namespace based on the at least one second parameter;
attach the first namespace to the first controller of the NVM boot drive;
attach the second namespace to a second controller of the NVM boot drive, the second controller associated with a virtual function of the NVM boot drive; and
attach the second controller to a bootloader of a second processor circuit.

2. The at least one non-transitory machine-readable storage medium of claim 1, wherein the first controller is associated with the at least one first processor circuit.

3. The at least one non-transitory machine-readable storage medium of claim 2, wherein the at least one first processor circuit and the second processor circuit are different types of processor circuits.

4. The at least one non-transitory machine-readable storage medium of claim 1, wherein the instructions cause one or more of the at least one first processor circuit to:
cause the first controller to create a shared namespace based on at least one third parameter; and
attach the shared namespace to the first controller and the second controller.

5. The at least one non-transitory machine-readable storage medium of claim 1, wherein the virtual function is a first virtual function of the NVM boot drive, and the instructions cause one or more of the at least one first processor circuit to:
cause the first controller to create a third namespace based on at least one third parameter; and
attach the third namespace to a third controller of the NVM boot drive, the third controller associated with a second virtual function of the NVM boot drive.

6. The at least one non-transitory machine-readable storage medium of claim 1, wherein the at least one second parameter includes a size for the second namespace and an indication of a mapping of the second namespace to the second processor circuit.

7. The at least one non-transitory machine-readable storage medium of claim 1, wherein the instructions cause one or more of the at least one first processor circuit to cause the second processor circuit to load the bootloader in a pre-boot execution environment.

8. An apparatus comprising:
interface circuitry;
machine-readable instructions; and
at least one first processor circuit to utilize the machine-readable instructions to:
determine at least one first parameter for a first namespace and at least one second parameter for a second namespace to be configured for a non-volatile memory (NVM) boot drive;
cause a first controller of the NVM boot drive to create the first namespace based on the at least one first parameter, the first controller associated with a physical function of the NVM boot drive;
cause the first controller to create the second namespace based on the at least one second parameter;
attach the first namespace to the first controller of the NVM boot drive;
attach the second namespace to a second controller of the NVM boot drive, the second controller associated with a virtual function of the NVM boot drive; and
attach the second controller to a bootloader of a second processor circuit.

9. The apparatus of claim 8, wherein the first controller is associated with the at least one first processor circuit.

10. The apparatus of claim 9, wherein the at least one first processor circuit and the second processor circuit are different types of processor circuits.

11. The apparatus of claim 8, wherein one or more of the at least one first processor circuit is to:
cause the first controller to create a shared namespace based on at least one third parameter; and
attach the shared namespace to the first controller and the second controller.

12. The apparatus of claim 8, wherein the virtual function is a first virtual function of the NVM boot drive, and one or more of the at least one first processor circuit is to:
cause the first controller to create a third namespace based on at least one third parameter; and
attach the third namespace to a third controller of the NVM boot drive, the third controller associated with a second virtual function of the NVM boot drive.

13. The apparatus of claim 8, wherein the at least one second parameter includes a size for the second namespace and an indication of a mapping of the second namespace to the second processor circuit.

14. The apparatus of claim 8, wherein one or more of the at least one first processor circuit is to cause the second processor circuit to load the bootloader in a pre-boot execution environment.

15. A method comprising:
determining at least one first parameter for a first namespace and at least one second parameter for a second namespace to be configured for a non-volatile memory (NVM) boot drive;
causing a first controller of the NVM boot drive to create the first namespace based on the at least one first parameter, the first controller associated with a physical function of the NVM boot drive;
causing the first controller to create the second namespace based on the at least one second parameter;
attaching the first namespace to the first controller of the NVM boot drive;
attaching the second namespace to a second controller of the NVM boot drive, the second controller associated with a virtual function of the NVM boot drive; and
attaching, by executing at least one instruction with at least one first processor circuit, the second controller to a bootloader of a second processor circuit.

16. The method of claim 15, wherein the first controller is associated with the at least one first processor circuit.

17. The method of claim 16, wherein the at least one first processor circuit and the second processor circuit are different types of processor circuits.

18. The method of claim 15, further including:
causing the first controller to create a shared namespace based on at least one third parameter; and
attaching the shared namespace to the first controller and the second controller.

19. The method of claim 15, wherein the virtual function is a first virtual function of the NVM boot drive, and the method further includes:
causing the first controller to create a third namespace based on at least one third parameter; and
attaching the third namespace to a third controller of the NVM boot drive, the third controller associated with a second virtual function of the NVM boot drive.

20. The method of claim 15, wherein the at least one second parameter includes a size for the second namespace and an indication of a mapping of the second namespace to the second processor circuit.
